(19) United States
(12) Patent Application Publication
(10) Pub. No.: US 2015/0225524 A1
(43) Pub. Date: Aug. 13, 2015

(54) POLYESTER FILMS AND METHODS FOR MANUFACTURING THE SAME

(71) Applicant: INDUSTRIAL TECHNOLOGY RESEARCH INSTITUTE, Hsinchu (TW)

(72) Inventors: Meng-Hsin CHEN, Xinpi Township (TW); Chih-Hsiang LIN, Taipei City (TW); Chung-Cheng LIN, Kaohsiung City (TW)

(73) Assignee: INDUSTRIAL TECHNOLOGY RESEARCH INSTITUTE, Hsinchu (TW)

(21) Appl. No.: 14/585,420

(22) Filed: Dec. 30, 2014

Related U.S. Application Data
(60) Provisional application No. 61/937,139, filed on Feb. 7, 2014.

(30) Foreign Application Priority Data
Sep. 1, 2014 (TW) 103130071

(51) Int. Cl. C08J 5/18

(52) U.S. Cl. CPC C08J 5/18; C08J 2367/03

(57) ABSTRACT

A polyester film is provided. The polyester film is produced from a composition that includes the following monomers: terephthalic acid, ethylene glycol, and a branched monomer having a structure represented by formula (I), formula (II) or formula (III):

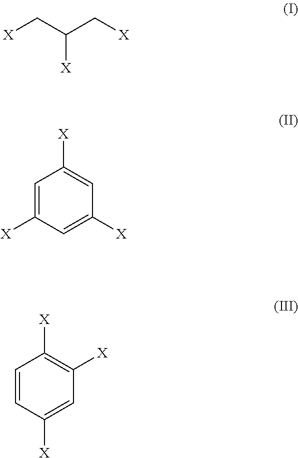

, wherein X is independently hydroxyl, carboxyl or —COOR, and R is C₁-₆ alkyl. The molar ratio between terephthalic acid and ethylene glycol ranges is between about 50:50 and 30:70. The molar percentage of the branched monomer is from about 1 mol % to 3 mol %, based on the total mole of terephthalic acid and ethylene glycol.

### CROSS REFERENCE TO RELATED APPLICATION

This application claims the benefit of U.S. Provisional Application No. 61/937,139, filed on Feb. 7, 2014, which is incorporated herein by reference.

The application is based on, and claims priority from, Taiwan Application Serial Number 103130071, filed on Sep. 1, 2014, the disclosure of which is incorporated by reference herein in its entirety.

### TECHNICAL FIELD

The technical field relates to a polyester film and a method for preparing the same.

### BACKGROUND

Polyester films have been widely applied in various applications. In response to changing environments, polyester films can be customized to meet the specific needs. For example, the backsheet of a solar module is made of polyester, and the top and bottom surface of the backsheet are coated with DuPont™ Tedlar films. Since the solar module operates under high temperatures and high humidity, a backsheet with good weather resistance (such as thermal resistance and water resistance) is apt to be used for manufacturing solar modules.

Therefore, a novel polyester which overcomes the above difficulties and inconveniences is desired.

According to an embodiment of the disclosure, a polyester film is provided. The polyester film can include the reaction product of a composition, wherein the composition can substantially consist of: a terephthalic acid monomer, an ethylene glycol monomer, and a branched monomer. The branched monomer has a structure represented by formula (I), formula (II) or formula (III):

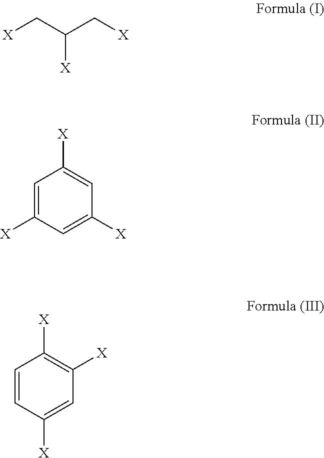

wherein X is independently hydroxyl, carboxyl or —COOR, and R is C₁₋₆ alkyl; the molar ratio between the terephthalic acid monomer and the ethylene glycol monomer is from about 50:50 to 30:70; and the branched monomer has a molar percentage of between about 1 mol % and 3 mol %, based on the total mole of the terephthalic acid monomer and the ethylene glycol monomer.

According to another embodiment of the disclosure, a method for preparing a polyester film is provided. The method for preparing a polyester film includes reacting a branched monomer with a mixture, wherein the mixture consists of a terephthalic acid monomer and an ethylene glycol monomer, wherein the branched monomer has a structure represented by formula (I), formula (II) or formula (III):

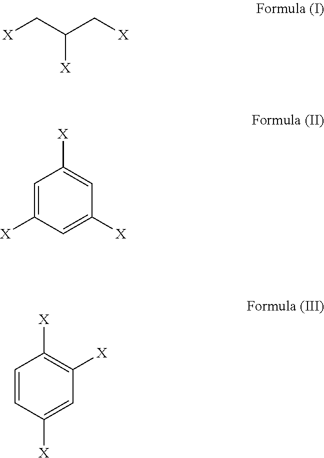

wherein X is independently hydroxyl, carboxyl or —COOR, and R is C₁₋₆ alkyl; and wherein, the branched monomer has a molar percentage of between about 1 mol % to 3 mol %, based on the total mole of the terephthalic acid monomer and the ethylene glycol monomer.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a graph plotting the water-resistance time of the polyester chips disclosed in Examples 1-3 and Comparative Examples 1-3.

FIG. 2 is a graph plotting the water-resistance time of the polyester chips disclosed in Examples 4-6 and Comparative Examples 1 and 4.

FIG. 3 is a graph plotting the water-resistance time of the polyester chips disclosed in Examples 7-9 and Comparative Example 1.

FIG. 4 is a graph plotting the result of the polyester films disclosed in Examples 10-12 and Comparative Examples 5-6 measured by a thermomechanical analysis.

FIG. 5 is a graph plotting the result of the polyester films disclosed in Examples 11-12 and Comparative Examples 5-6 measured by a dimensional stability test.

FIG. 6 is a graph plotting the extension half-cycle of the polyester films disclosed in Examples 10-12 and Comparative Examples 5-6.

### DETAILED DESCRIPTION

The disclosure provides a polyester film, which includes a reaction product of a composition. The composition substantially consists of: a terephthalic acid monomer; an ethylene glycol monomer; and a branched monomer, having a structure represented by formula (I), formula (II) or formula (III):

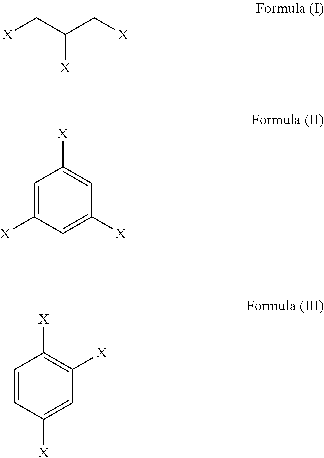

wherein X is independently hydroxyl, carboxyl or —COOR, and R is C₁₋₆ alkyl.

According to one embodiment, the molar ratio of the terephthalic acid monomer and the ethylene glycol monomer is between about 50:50 and 30:70. According to another embodiment, the branched monomer has a molar percentage of between about 1 mol % to 3 mol %, based on the total mole of the terephthalic acid monomer and the ethylene glycol monomer. According to another embodiment, the branched monomer has a molar percentage of between 1.5 mol % to 3 mol %, based on the total mole of the terephthalic acid monomer and the ethylene glycol monomer. term “between” of the disclosure is used to identify a range and includes the limits of the identified range. For example, “the branched monomer has a molar percentage of between about 1 mol % and 3 mol %” includes the explicitly recited limits of 1 mol % and 3 mol %. When the molar percentage of the branched monomer is less than 1 mol %, the polyester film has lower water resistance. When the molar percentage of the branched monomer is more than 3 mol %, the polyester film has lower thermal resistance. The addition of the branched monomer can promote the esterification and condensation of the terephthalic acid monomer and the ethylene glycol monomer, resulting in reducing the amount of terminal acid groups of the polyester of the disclosure and restraining the formation of oligomer during the esterification. Therefore, the obtained polyester of the disclosure exhibits higher water resistance and dimensional stability resulting from the movement of the molecular chains of the polyester.

According to an embodiment of the disclosure, the branched monomer, the terephthalic acid monomer, and the ethylene glycol monomer can simultaneously be mixed and subjected to an esterification. The esterification can have a process temperature between 250° C. and 280° C. The reaction product of the esterification is subjected to a pelletizing process to form first polyester chips. In one embodiment of the disclosure, the first polyester chips of the disclosure have a polyester oligomer weight percentage not more than 1.2 wt % (such as between 0.6 wt % and 1.2 wt %), based on the weight of the first polyester chips. In another embodiment of the disclosure, the first polyester chips of the disclosure have an acid value equal to or less than 33 eq/10⁶ g, such as between 5 eq/10⁶ g and 33 eq/10⁶ g, or between 10 eq/10⁶ g and 25 eq/10⁶ g. According to embodiments of the disclosure, the first polyester chips of the disclosure have a glass transition temperature (Tg) between 77° C. and 100° C., such as between 77° C. and 90° C. According to another embodiment of the disclosure, the first polyester chips of the disclosure have an inherent (IV) between 0.1 lnηᵣ/C and 0.9 lnηᵣ/C or between 0.5 lnηᵣ/C and 0.7 lnηᵣ/C.

According to another embodiment of the disclosure, the terephthalic acid monomer, and the ethylene glycol monomer can be mixed and subjected to an esterification in advance, obtaining a polyethylene terephthalate (PET). Next, the polyethylene terephthalate is reacted with the branched monomer at a temperature between 260° C. and 300° C. The reaction product is then subjected to a pelletizing process to form second polyester chips. In particular, the molar ratio between the terephthalic acid monomer and the ethylene glycol monomer can be between 1:1.2 and 1:1.4, and the esterification can have a process temperature between 250° C. and 280° C., and a process time between 1 hr and 3 hrs. In one embodiment of the disclosure, the second polyester chips of the disclosure have a polyester oligomer weight percentage not more than 1.2 wt % (such as between 0.6 wt % and 1.2 wt %), based on the weight of the polyester chips. In one embodiment of the disclosure, the second polyester chips of the disclosure have an acid value equal to or less than 33 eq/10⁶ g, such as between 5 eq/10⁶ g and 33 eq/10⁶ g, or between 10 eq/10⁶ g and 25 eq/10⁶ g. According to embodiments of the disclosure, the second polyester chips of the disclosure have a glass transition temperature (Tg) between 77° C. and 100° C., such as between 77° C. and 90° C. According to another embodiment of the disclosure, the polyester chips of the disclosure have an inherent viscosity (IV) between 0.1 lnηᵣ/C and 0.9 lnηᵣ/C or between 0.5 lnηᵣ/C and 0.7 lnηᵣ/C.

According to an embodiment of the disclosure, the first or second polyester chips can be subjected to a melt-extrusion process to form a sheet. According to one embodiment of the disclosure, the extrusion process can employ a continuous extrusion machine (such as a twin-screw extruder or a co-extrusion extruder). The extrusion process has a process temperature between 200° C. and 350° C., or between 250° C. and 330° C. The twin-screw extruder can have a spin speed between 50 rpm and 300 rpm. After extruding by the sheet having a uniform thickness is obtained via a casting drum. The process temperature of the casting drum is lower than the glass transition temperature (Tg) in general, in order to ensure the polyester can be cooled rapidly after melting. According to another embodiment of the disclosure, the thickness of the sheet can be between 100 μm and 500 μm, or 200 μm and 350 μm.

Next, the sheet can be subjected to a biaxial stretching process to form a polyester film. During the biaxial stretching process, the sheet is heated at a temperature that is higher than the glass transition temperature thereof. Next, the heated sheet is stretched in the machine direction (MD) and the transverse direction (TD) respectively or simultaneously at a fixed speed. According to an embodiment of the disclosure, the biaxial stretching process can employ a Biaxial stretching machine. The biaxial stretching process can have a process temperature between 60° C. and 100° C., or 80° C. and 90° C., and the fixed speed can be between 100 mm/min and 800 mm/min, or between 300 mm/min and 500 mm/min. Furthermore, the biaxial stretching process can have a stretching ratio between 1×1 and 9×9, or between 3×3 and 5×5.

According to an embodiment, the polyester film of the disclosure has an oligomer weight percentage not more than 1.2 wt %, such as between 0.6 wt % and 1.2 wt %. The polyester film has an acid value equal to or less than 33 eq/10⁶ g, such as between 5 eq/10⁶ g and 33 eq/10⁶ g, or between 10 eq/10⁶ g and 25 eq/10⁶ g. The polyester film has an glass transition temperature (Tg) between 77° C. and 100° C., such as between 77° C. and 90° C. According to some embodiments of the disclosure, the polyester film has a water-resistance time longer than 40 hr, such as 69 hr.

Below, exemplary embodiments will be described in detail with reference to accompanying drawings so as to be easily realized by a person having ordinary knowledge in the art. The disclosed concept may be embodied in various forms without being limited the exemplary embodiments set forth herein. Descriptions of well-known parts are omitted for clarity, and like reference numerals refer to like elements throughout.

### Preparation and Measurement of Polyester Chips

### EXAMPLE 1

Terephthalic acid monomer (1 eq), ethylene glycol monomer (1 eq), and 1.0 mol % (based on the total mole of the terephthalic acid monomer and the ethylene glycol monomer) branched monomer (1) (glycerol, having a structure of

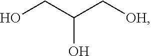

manufactured and sold by Sigma-Aldrich) were mixed, and heated at 280° C. for 90 mins, obtaining modified polyethylene terephthalate (PET). After the polyethylene terephthalate was extruded into cooling water and pelletized, polyester chips were obtained. Next, the inherent viscosity (IV), glass transition temperature (Tg), melting point (Tm), acid value, and oligomer weight percentage of the polyester chips were measured, and the results are shown in Table 1. The method for measuring the inherent viscosity (IV), glass transition temperature (Tg), melting point (Tm), acid value, and oligomer weight percentage are disclosed below.

Inherent viscosity (IV): the polyester chip was dissolved in phenol/trichloroethylene (TCE) at 30° C. The solution was stirred by a Stirring motor (115V.50/60CY, 1.2A, 1550 RPM), and then the inherent viscosity of the solution was measured by viscometer.

Glass transition temperature (Tg): the polyester chip (5-10 mg) was heated to 800° C. (at a heating rate of 20° C./min), and the weight of the polyester chip was measured by thermogravimetry analyzer (TGA) under a nitrogen atmosphere.

Melting point (Tm): the melting point of the polyester chip (5-10 mg) was measured by a differential scanning calorimeter (DSC) under a nitrogen atmosphere. value : the polyester chip (1.0 g) was dissolved in o-cresol (80 ml), and heated to 85° C. After cooling to room temperature, water (4 ml) was added into the solution. Next, the acid value of the solution was determined by acid/base titration utilizing 0.1N potassium hydroxide (KOH) ethanol solution and a potentiometric titrator (Metrohm 702 SM).

Oligomer weight percentage: The oligomer of the polyester chip was extracted by a soxhlet extractor, and then the weight of the oligomer was measured.

### EXAMPLES 2-3

Examples 2-3 were performed in the same manner as in Example 1 except that the molar ratio of the branched monomer (1) was increased from 1.0 mol % to 1.5 mol % and 3.0 mol % respectively. Next, the inherent viscosity (IV), glass transition temperature (Tg), melting point (Tm), acid value, and oligomer weight percentage of the obtained polyester chips were measured, and the results are shown in Table 1.

### COMPARATIVE EXAMPLES 1-3

Comparative Examples 1-3 were performed in the same manner as in Example 1 except that the molar ratio of the branched monomer (1) was changed from 1.0 mol % to 0 mol %, 0.5 mol % and 5.0 mol % respectively. Next, the inherent viscosity (IV), glass transition temperature (Tg), melting point (Tm), acid value, and oligomer weight percentage of the obtained polyester chips were measured, and the results are shown in Table 1.

TABLE 1

| | Branched | | | | |
|---|---|---|---|---|---|
| | monomer (1) | IV | Tg | COOH | Oligomer |
| | (mol %) | (lnηᵣ/C) | (° C.) | (eq/10⁶ g) | (wt %) |
| Comparative | 0 | 0.63 | 76.72 | 53 | 2.3 |
| Example 1 | | | | | |
| Comparative | 0.5 | 0.61 | 76.02 | 35 | 1.5 |
| Example 2 | | | | | |
| Example 1 | 1.0 | 0.60 | 77.01 | 33 | 1.2 |
| Example 2 | 1.5 | 0.62 | 77.24 | 23 | 0.8 |
| Example 3 | 3.0 | 0.64 | 77.55 | 21 | 0.9 |
| Comparative | 5.0 | 0.63 | 72.85 | 20 | 1.1 |
| Example 3 | | | | | |

### EXAMPLE 4

Terephthalic acid monomer (1 eq), ethylene glycol monomer (1 eq), and 1.0 mol % (based on the total mole of the terephthalic acid monomer and the ethylene glycol monomer) branched monomer (2) (trimesic acid, having a structure of

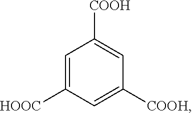 [SMILES: O=C(O)c1cc(C(=O)O)cc(C(=O)O)c1]

manufactured and sold by Sigma-Aldrich) were mixed, and heated at 280° C. for 90 mins, obtaining modified polyethylene terephthalate (PET). After the polyethylene terephthalate was extruded into cooling water and pelletized, polyester chips were obtained. Next, the inherent viscosity (IV), glass transition temperature (Tg), melting point (Tm), acid value, and oligomer weight percentage of the polyester chips were measured, and the results are shown in Table 2.

### EXAMPLE 5-6

Examples 5-6 were performed in the same manner as in Example 4 except that the molar ratio of the branched monomer (2) was increased from 1.0 mol % to 1.5 mol % and 3.0 mol % respectively. Next, the inherent viscosity (IV), glass transition temperature (Tg), melting point (Tm), acid value, and oligomer weight percentage of the obtained polyester chips were measured, and the results are shown in Table 2.

### COMPARATIVE EXAMPLE 4

Comparative Example 4 was performed in the same manner as in Example 4 that the molar ratio of the branched monomer (1) was reduced from 1.0 mol % to 0.5 mol %. Next, the inherent viscosity (IV), glass transition temperature (Tg), melting point (Tm), acid value, and oligomer weight percentage of the obtained polyester chips were measured, and the results are shown in Table 2.

TABLE 2

| | Branched | | | | |
|---|---|---|---|---|---|
| | monomer (2) | IV | Tg | COOH | Oligomer |
| | (mol %) | (lnηᵣ/C) | (° C.) | (eq/10⁶ g) | (wt %) |
| Comparative | 0 | 0.63 | 76.72 | 53 | 2.3 |
| Example 1 | | | | | |
| Comparative | 0.5 | 0.65 | 87.24 | 26 | 1.4 |
| Example 4 | | | | | |
| Example 4 | 1.0 | 0.65 | 87.18 | 23 | 1.2 |
| Example 5 | 1.5 | 0.66 | 87.32 | 18 | 0.8 |
| Example 6 | 3.0 | 0.64 | 87.38 | 16 | 0.8 |

### EXAMPLE 7

Terephthalic acid monomer (1 eq), ethylene glycol monomer (1 eq), and 1.0 mol % (based on the total mole of the terephthalic acid monomer and the ethylene glycol monomer) branched monomer (3) (trimethyl trimellitate, having a structure of

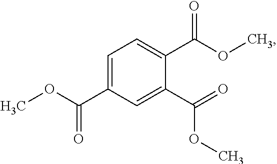 [SMILES: COC(=O)c1ccc(C(=O)OC)c(C(=O)OC)c1]

manufactured and sold by Sigma-Aldrich) were mixed, and heated at 280° C. for 90 mins, obtaining modified polyethylene terephthalate (PET). After the polyethylene terephthalate was extruded into cooling water and pelletized, polyester chips were obtained. Next, the inherent viscosity (IV), glass transition temperature (Tg), melting point (Tm), acid value, and oligomer weight percentage of the polyester chips were and the results are shown in Table 3.

### EXAMPLES 8-9

Examples 8-9 were performed in the same manner as in Example 7 except that the molar ratio of the branched monomer (3) was increased from 1.0 mol % to 1.5 mol % and 3.0 mol % respectively. Next, the inherent viscosity (IV), glass transition temperature (Tg), melting point (Tm), acid value, and oligomer weight percentage of the obtained polyester chips were measured, and the results are shown in Table 3.

TABLE 3

| | Branched | | | | |
|---|---|---|---|---|---|
| | monomer (3) | IV | Tg | COOH | Oligomer |
| | (mol %) | (lnηr/C) | (° C.) | (eq/10⁶ g) | (wt %) |
| Comparative | 0 | 0.63 | 76.72 | 53 | 2.3 |
| Example 1 | | | | | |
| Example 7 | 1.0 | 0.66 | 84.52 | 21 | 1.1 |
| Example 8 | 1.5 | 0.65 | 84.03 | 18 | 0.9 |
| Example 9 | 3.0 | 0.63 | 85.33 | 15 | 0.9 |

As shown in Table 1-3, with the increase of the branched monomer, the acid value of the polyester chip is reduced. The acid value of the polyester chips of the disclosure can be equal to or less than 33 eq/10⁶ g, and the oligomer weight percentage of the polyester chips of the disclosure can be equal to or less than 1.2%. According to Examples 1-8 and Comparative Examples 1-3, the suitable addition (1 mol %-3 mol %) of the branched monomer can enhance the glass transition temperature (Tg) of the polyester chips and reduce the acid value and the oligomer weight percentage of the polyester chips.

### Water Resistance Test of Polyester Chips

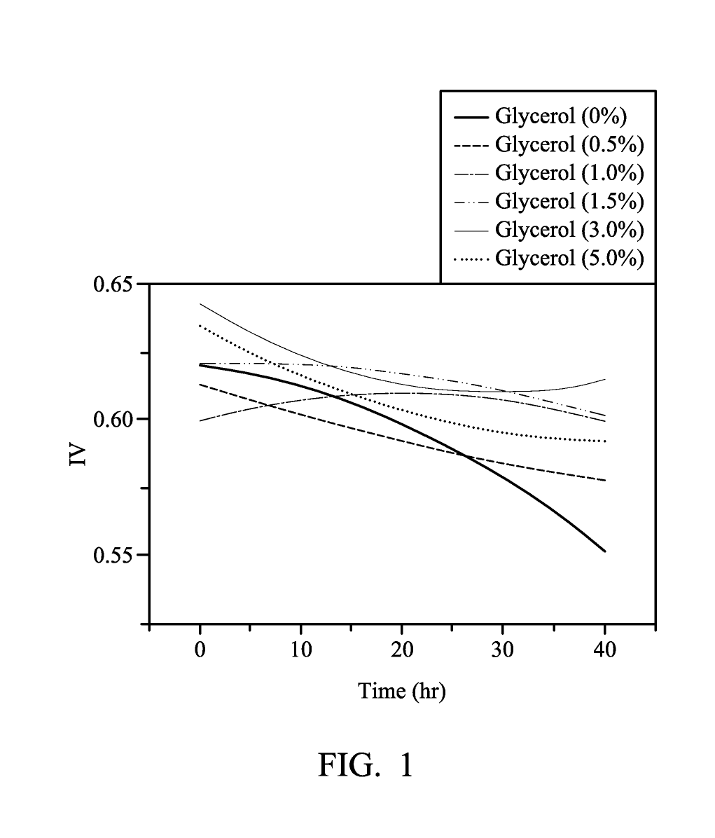

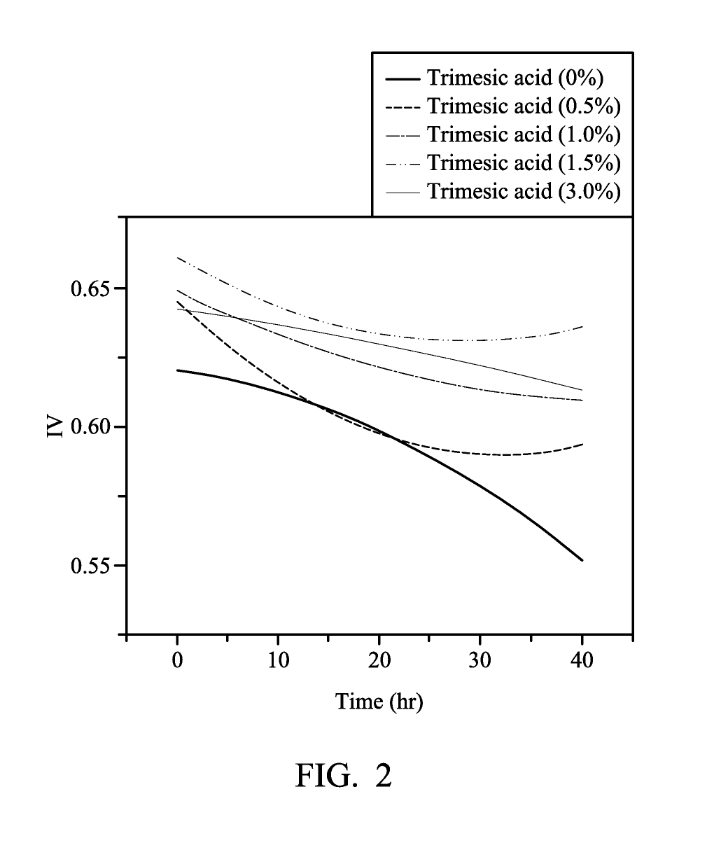

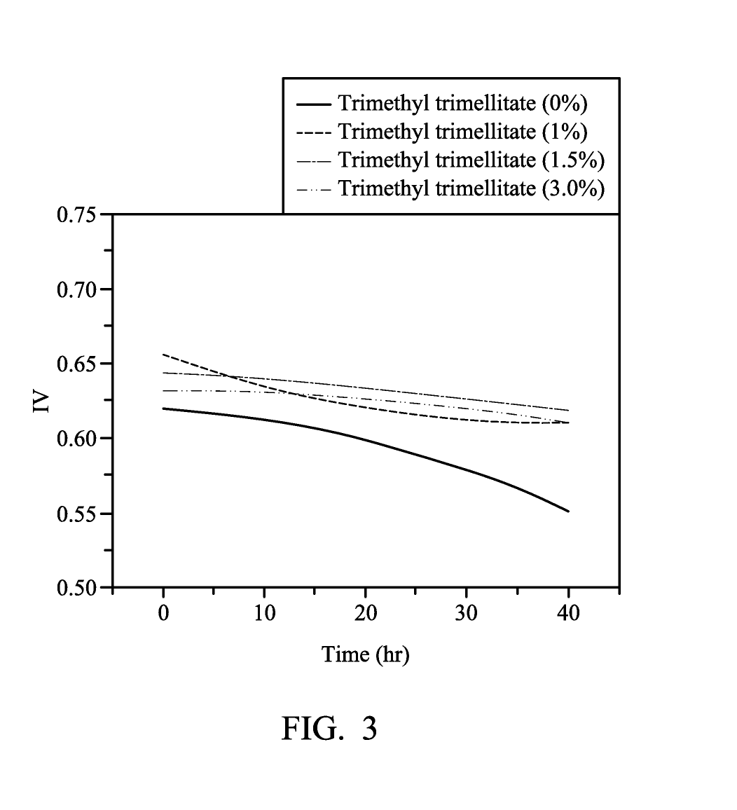

The polyester chips of Examples 1-3 and Comparative Examples 1-3 were boiled in water at 100° C. for 40 hrs, and the inherent viscosities (IV) thereof were measured time, and the results are shown in FIG. 1. Further, the polyester chips of Examples 4-6 and Comparative Examples 1 and 4 were boiled in water at 100° C. for 40 hrs, and the inherent viscosities (IV) thereof were measured versus time, and the results are shown in FIG. 2. Moreover, the polyester chips of Examples 7-9 and Comparative Example 1 were boiled in water at 100° C. for 40 hrs, and the inherent viscosities (IV) thereof were measured versus time, and the results are shown in FIG. 3. As shown in Tables 1-3 and FIGS. 1-3, when the amount of the branched monomer is between 1 mol % and 3 mol %, the polyester chips can exhibit high glass transition temperature (Tg), low acid value and low oligomer weight percentage.

### Preparation and Measurement of the Polyester Film

### EXAMPLES 10-12

The polyester chips of Examples 4-6 were dried at 140° C. under vacuum for 8 hrs. Next, films with a thickness of 270 μm were fabricated from the polyester chips via a continuous extrusion machine (HP CF320401803 1/2). Next, after preheating for 5 mins, the films were subjected to a biaxial stretching process at a temperature of about 85-90° C. with a stretching rate of about 300-500 mm/min The films were stretched threefold in the machine direction (MD) and the transverse direction (TD) respectively, and then heated at about 200-230° C. for heat setting, obtaining polyester films of the disclosure with a thickness of 30±2 μm.

The inherent viscosity (IV), glass transition temperature (Tg), melting point (Tm), acid value, and oligomer weight percentage of the obtained polyester films were measured. Results show that the polyester chips of Examples 4-6 and the polyester films prepared therefrom have similar properties. Furthermore, the coefficient of thermal expansion, the heat shrinkage rate, and the average thickness of the polyester films were measured, and the results are shown in Table 4.

The method for measuring the coefficient of thermal expansion (CTE) and heat shrinkage rate of the polyester films is disclosed below.

Coefficient of thermal expansion (CTE): The coefficient of thermal expansion of the polyester films was measured by determining the size changes via a thermal mechanical analyzer (TMA).

Heat shrinkage rate (150° C., 30mins): An oven was provided and then preheated at 150° C. for 1 hr. Next, the polyester films (30×30 cm) were disposed in the oven. After 30 mins, the size changes of the polyester films were measured.

### COMPARATIVE EXAMPLE 5-6

The polyester chips of Comparative Examples 1 and 4 were dried at 140° C. under a vacuum for 8 hrs. Next, films with a thickness of 270 μm were fabricated from the polyester chips via a continuous extrusion machine (HP CF320401803 1/2). Next, after preheating for 5 mins, the films were subjected to a biaxial stretching process at a temperature of about 85-90° C. with a stretching rate of about 300-500 mm/min The films were stretched three folds in the machine direction (MD) and the transverse direction (TD) respectively, and then heated at about 200-230° C. for heat setting, obtaining the polyester films of the disclosure with a thickness of 30±2 μm. Next, the coefficient of thermal expansion (CTE), the heat shrinkage rate the, and the average thickness of the obtained polyester films were measured, and the results are shown in Table 4.

TABLE 4

| | | CTE | heat shrinkage |
|---|---|---|---|
| | polyester | (ppm/° C.) | (150° C., 30 mins) |
| | chips | (MD/TD) | (MD/TD)(%) |
| Example 10 | Example 4 | (19.2/15.1) | (0.8/0.5) |
| Example 11 | Example 5 | (16.7/12.9) | (0.6/0.5) |
| Example 12 | Example 6 | (15.2/10.9) | (0.5/0.3) |
| Comparative | Comparative | (40.8/37.4) | (2.2/1.7) |
| Example 5 | Example 1 | | |
| Comparative | Comparative | (30.9/27.9) | (1.7/1.3) |
| Example 6 | Example 4 | | |

As shown in Table 4, the suitable addition of the branched monomer can reduce the heat shrinkage of the polyester film.

### Thermomechanical Analysis

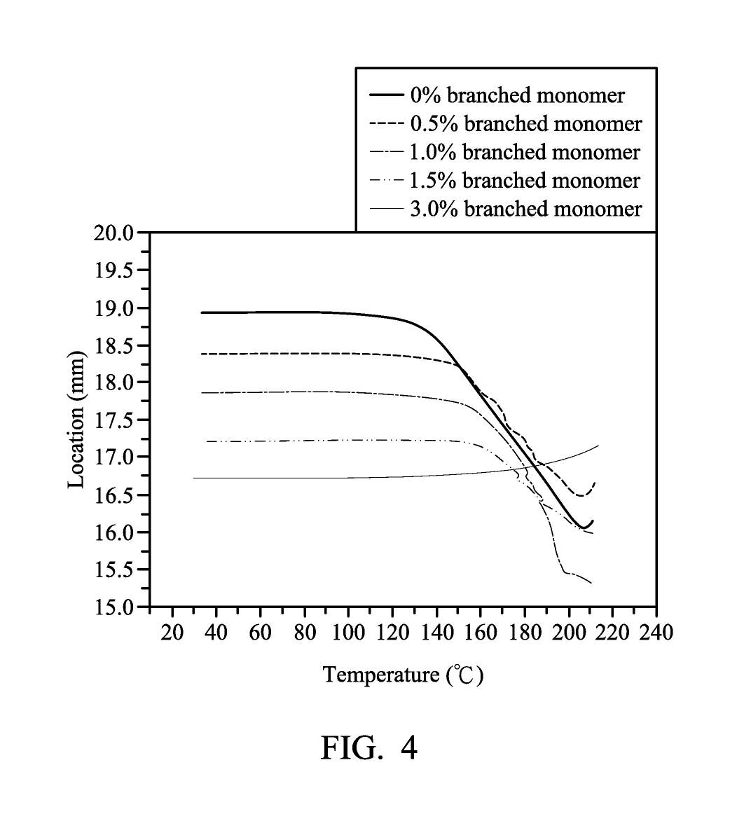

The thermomechanical properties within 30-220° C. of the polyester films disclosed in Examples 10-12 and Comparative Examples 5-6 were measured by a thermal mechanical analyzer (TMA) with a heating rate of 10° C./min, and the results are shown in FIG. 4. The polyester film of Comparative Example 4 was plastically deformed at 120° C. On the other hand, the polyester film of Example 6 was plastically deformed at 180° C. Therefore, the suitable addition of the branched monomer can improve the thermal resistance of the polyester film.

### Dimensional Stability Test

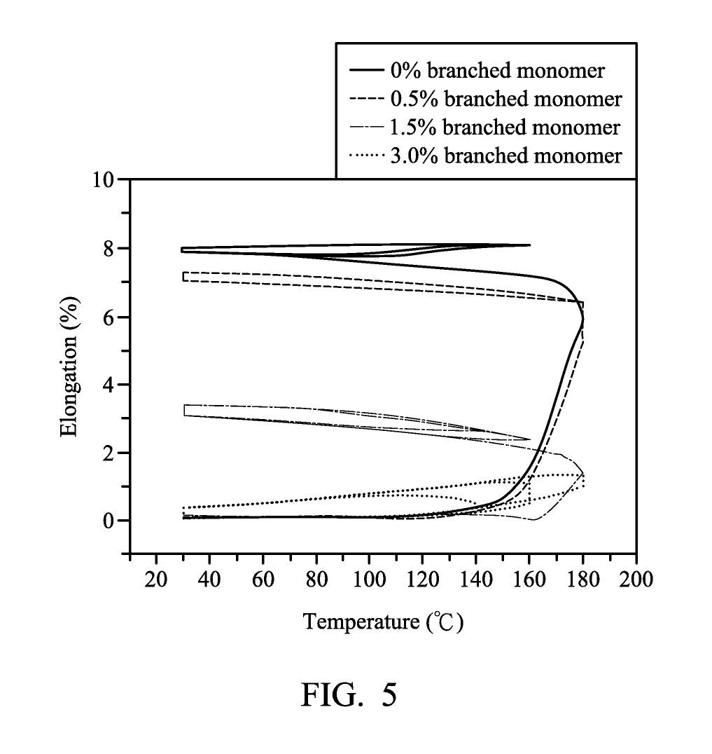

The polyester films disclosed in Examples 11-12 and Comparative Examples 5-6 were heated to 180° C. and cooled down to 30° C. three times with a heating rate of 10° C./min and a cooling rate of 40° C./min, and then the dimensional stability thereof was measured. The results are shown in FIG. 5. As shown in FIG. 5, the suitable addition of the branched monomer can improve the dimensional stability of the polyester film.

### Water Resistance Test

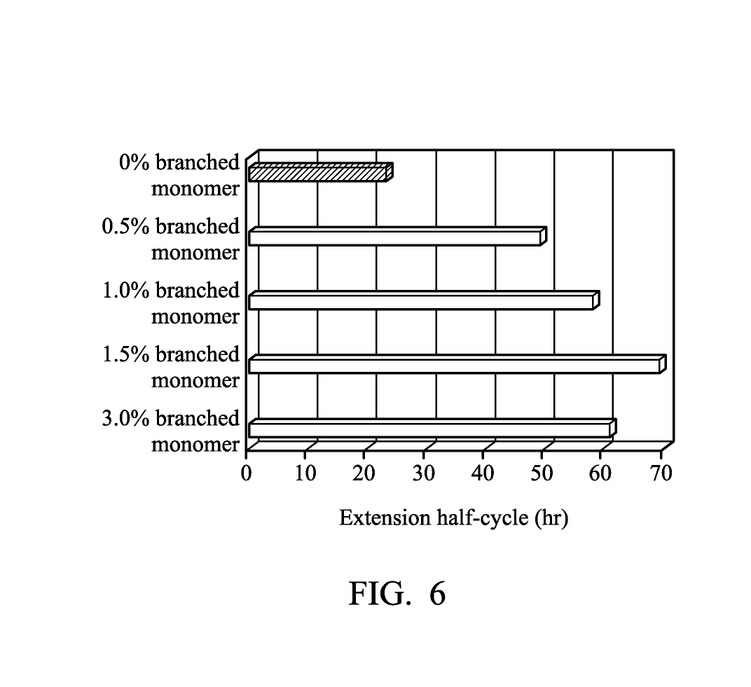

The polyester films disclosed in Examples 10-12 and Comparative Examples 5-6 were boiled in water at 121° C., 100% RH, and high pressure. Next, the polyester films with various boil times were subjected to a tensile-break strength test according to ASTM D882-61, and then the extension half-cycle of the polyester films were determined, as shown in FIG. 6. The extension half-cycle of the Examples 10-12 is longer than 40 hrs, even longer than 50 hr. The polyester film of Example 12 has an extension half-cycle of 69 hr. It means that the polyester film of Example 12 can be stretched at least 150% after boiling in water under 121° C. and 100% RH for 69 hrs. As shown in FIG. 6, the suitable addition of the branched monomer can improve the water-resistance time of the polyester film.

Accordingly, the polyester films of the disclosure have lower acid value and oligomer weight percentage and improved glass transition temperature (Tg) and water resistance. Therefore, the polyester films of the disclosure have high weather resistance and are suitable for operating under high temperature and high humidity.

It will be apparent to those skilled in the art that various modifications and variations can be made to the disclosed methods and materials. It is intended that the specification and examples be considered as exemplary only, with a true scope of the disclosure being indicated by the following claims and their equivalents.

What is claimed is:

1. A polyester film, comprising a reaction product of a composition, wherein the composition substantially consists of:
a terephthalic acid monomer;
an ethylene glycol monomer; and
a branched monomer, having a structure represented by formula (I), formula (II), or formula (III): 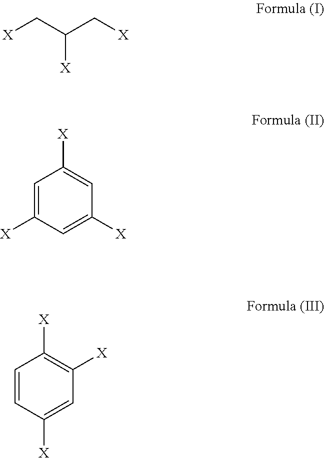
wherein X is independently hydroxyl, carboxyl or —COOR, and R is C₁₋₆ alkyl;
the molar ratio between the terephthalic acid monomer and the ethylene glycol monomer is between 50:50 and 30:70; and the branched monomer has a molar percentage of between 1.5 mol % to 3 mol %, based on the total mole of the terephthalic acid monomer and the ethylene glycol monomer.

2. The polyester film as claimed in claim 1, wherein the molar percentage of the branched monomer is between 1 mol % to 3 mol %, based on the total mole of the terephthalic acid monomer and the ethylene glycol monomer.

3. The polyester film as claimed in claim 1, wherein the polyester film has an acid value equal to or less than 33 eq/106 g.

4. The polyester film as claimed in claim 1, wherein the polyester film has an acid value between 5 eq/10⁶ g and 33 eq/10⁶ g.

5. The polyester film as claimed in claim 1, wherein the polyester film has an acid value between 10 eq/10⁶ g and 25 eq/10⁶ g.

6. The polyester film as claimed in claim 1, wherein the polyester film has a polyester oligomer weight percentage not more than 1.2 wt %, based on the weight of the polyester film.

7. The polyester film as claimed in claim 1, wherein the polyester film has a polyester oligomer weight percentage between 0.6 wt % and 1.2 wt %, based on the weight of the polyester film.

8. The polyester film as claimed in claim 1, wherein the polyester film has a glass transition temperature (Tg) between 77° C. and 100° C.

9. The polyester film as claimed in claim 1, wherein the polyester film has a glass transition temperature (Tg) between 77° C. and 90° C.

10. The polyester film as claimed in claim 1, wherein the polyester film has a water-resistance time longer than 40 hrs.

11. The polyester film as claimed in claim 1, wherein the polyester film has a water-resistance time longer than 69 hrs.

12. A method for preparing a polyester film, comprising:
reacting a branched monomer with a mixture, wherein the mixture consists of a terephthalic acid monomer, and an ethylene glycol monomer, wherein the branched monomer has a structure represented by formula (I), formula (II), or formula (III): 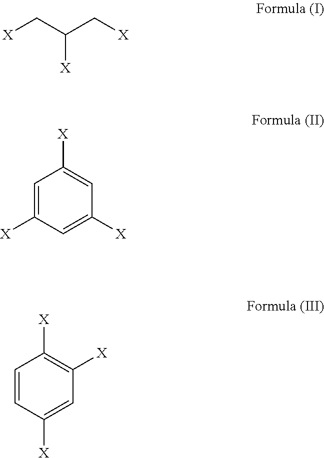
wherein X is independently hydroxyl, carboxyl or —COOR, and R is C₁₋₆ alkyl;
and wherein the branched monomer has a molar percentage of between 1 mol % to 3 mol %, based on the total mole of the terephthalic acid monomer and the ethylene glycol monomer.

13. The method for preparing a polyester film as claimed in claim 12, wherein the molar percentage of the branched monomer is between 1.5 mol % to 3 mol %, based on the total mole of the terephthalic acid monomer and the ethylene glycol monomer.

14. The method for preparing a polyester film as claimed in claim 12, wherein the branched monomer reacts with the terephthalic acid monomer, and the ethylene glycol monomer via an esterification to obtain a reaction product, and wherein the method for preparing the polyester film further comprises:
forming polyester chips from the reaction product via a pelletizing process;
subjecting the polyester chips to a melt-extrusion process to form a sheet; and
subjecting the sheet to a biaxial stretching process to form the polyester film.

15. The method for preparing a polyester film as claimed in claim 14, wherein the melt-extrusion process has a process temperature between 200° C. and 350° C.

16. The method for preparing a polyester film as claimed in claim 14, wherein the polyester film has a polyester oligomer weight percentage not more than 1.2 wt %, based on the weight of the polyester film.

17. The method for preparing a polyester film as claimed in claim 12, wherein the terephthalic acid monomer reacts with the ethylene glycol monomer via an esterification to obtain a first reaction product, and the branched monomer is reacted with the first reaction product to obtain a second reaction product, and wherein the method for preparing the polyester film further comprises:
forming polyester chips from the second reaction product of the branched monomer and the mixture via a pelletizing process;
subjecting the polyester chips to a melt-extrusion process to form a sheet; and
subjecting the sheet to a biaxial stretching process to form the polyester film.

18. The method for preparing a polyester film as claimed in claim 17, wherein the molar ratio between the terephthalic acid monomer and the ethylene glycol monomer is between 1:1.2 and 1:1.4.

19. The method for preparing a polyester film as claimed in claim 17, wherein the melt-extrusion process has a process temperature between 200° C. and 350° C.

20. The method for preparing a polyester film as claimed in claim 17, wherein the polyester film has a polyester oligomer weight percentage not more than 1.2 wt %, based on the weight of the polyester film.
